(19) United States
(12) Patent Application Publication
(10) Pub. No.: US 2025/0209276 A1
(43) Pub. Date: Jun. 26, 2025

(54) METHOD AND SYSTEM FOR EVALUATING ARTIFICIAL INTELLIGENCE MODELS VIA PERTURBATIONS

(71) Applicant: JPMorgan Chase Bank, N.A., New York, NY (US)

(72) Inventors: William WATSON, Long Beach, NY (US); Naan CHO, New York, NY (US); Tucker Richard BALCH, Suwanee, GA (US); Manuela VELOSO, New York, NY (US)

(73) Assignee: JPMorgan Chase Bank, N.A., New York, NY (US)

(21) Appl. No.: 18/396,014

(22) Filed: Dec. 26, 2023

(51) Int. Cl. G06F 40/30; G06F 9/54; G06F 18/24

(52) U.S. Cl. CPC G06F 40/30; G06F 9/543; G06F 18/24765

(57) ABSTRACT

A method for facilitating automated model evaluation based on question perturbations is disclosed. The method includes receiving, via an application programming interface, inputs that include an inquiry in a natural language format; generating, via a rephrasing model, questions based on the inquiry, each of the questions corresponding to a lexical variant of the inquiry; determine, via response models, an initial response for each of the questions and the inquiry; clustering the initial response for each of the questions and the inquiry into blocks based on shared characteristics; and computing metrics for each of the blocks.

### BACKGROUND

### 1. Field of the Disclosure

This technology generally relates to methods and systems for evaluating artificial intelligence models, and more particularly to methods, systems, and datasets for evaluating generated responses of large language models via automated crowdsourcing of question perturbations and corresponding answers.

### 2. Background Information

Many business entities implement artificial intelligence systems such as, for example, large language models to facilitate various operations and to provide services for users. Often, these artificial intelligence systems are implemented to process and analyze large quantities of data such as, for example, natural language data. Historically, implementations of conventional evaluation techniques for the artificial intelligence systems have resulted in varying degrees of success with respect to quantifying robustness and consistency of generated responses.

One drawback of the conventional evaluation techniques is that in many instances, risks of hallucinations are generally difficult to quantify in generated responses of the artificial intelligence systems. As a result, institutional adoption of the artificial intelligence systems is challenging due to uncertainties associated with the generated responses. Additionally, due to difficulties related to the assessment of generated responses, the artificial intelligence systems offer limited insights into their chain of thought as well as robustness of their answers.

Therefore, there is a need for a systematic approach that evaluates the robustness and consistency of generated responses by automatically crowdsourcing question perturbations through independent artificial intelligence agents.

### SUMMARY

The present disclosure, through one or more of its various aspects, embodiments, and/or specific features or sub-components, provides, inter alia, various systems, servers, devices, methods, media, programs, and platforms for evaluating generated responses of large language models via automated crowdsourcing of question perturbations and corresponding answers.

According to an aspect of the present disclosure, a method for facilitating automated model evaluation based on question perturbations is disclosed. The method is implemented by at least one processor. The method may include receiving, via an application programming interface, at least one input, each of the at least one input may include an inquiry in a natural language format; generating, via a rephrasing model, at least one question based on the inquiry, each of the at least one question may correspond to a lexical variant of the inquiry; determining, via at least one response model, an initial response for each of the at least one question and the inquiry; clustering the initial response for each of the at least one question and the inquiry into at least one block based on at least one shared characteristic; and computing at least one metric for each of the at least one block.

In accordance with an exemplary embodiment, the method may further include ranking the at least one block based on the computed at least one metric; and identifying a final response for the inquiry based on a result of the ranking.

In accordance with an exemplary embodiment, the method may further include generating at least one classification report for the inquiry based on the computed at least one metric, wherein the at least one metric may include a supervised metric and an unsupervised metric.

In accordance with an exemplary embodiment, each of the at least one question may relate to a natural language query that incorporates semantic meaning extracted from the inquiry, the semantic meaning may include subject matter that corresponds to the inquiry.

In accordance with an exemplary embodiment, to generate the at least one question based on the inquiry, the method may further include applying, via the rephrasing model, a predetermined transformation algorithm to the inquiry to generate each of the at least one question, wherein the predetermined transformation algorithm may perturb the inquiry to retain at least one semantic quality of the inquiry.

In accordance with an exemplary embodiment, the initial response for each of the at least one question and the inquiry may be independently determined by one of the at least one response model, the initial response may include at least one crowdsourced answer from a dataset.

In accordance with an exemplary embodiment, the at least one metric may include at least one from among an accuracy metric that relates to a baseline accuracy, a robustness metric that relates to correctness of at least one rater, a plurality voting metric that relates to aggregated responses by a mode of a corresponding answer set, an agreement metric that relates to the initial response, and a reliability metric that relates to a measure of internal consistency.

In accordance with an exemplary embodiment, the method may further include associating feedback data with the corresponding initial response when an agreement metric is below a predetermined agreement threshold, the feedback data may include the at least one metric; and determining, via the at least one response model, a subsequent response for each of the at least one question and the inquiry based on the feedback data.

In accordance with an exemplary embodiment, each of the at least one response model and the rephrasing model may include at least one from among a large language model, a deep learning model, a neural network model, a natural language processing model, a machine learning model, a mathematical model, and a process model.

According to an aspect of the present disclosure, a computing device configured to implement an execution of a method for facilitating automated model evaluation based on question perturbations is disclosed. The computing device including a processor; a memory; and a communication interface coupled to each of the processor and the memory, wherein the processor may be configured to receive, via an application programming interface, at least one input, each of the at least one input may include an inquiry in a natural language format; generate, via a rephrasing model, at least one question based on the inquiry, each of the at least one question may correspond to a lexical variant of the inquiry; determine, via at least one response model, an initial response for each of the at least one question and the inquiry; cluster the initial response for each of the at least one question and the inquiry into at least one block based on at least one shared characteristic; and compute at least one metric for each of the at least one block.

In accordance with an exemplary embodiment, the processor may be further configured to rank the at least one block based on the computed at least one metric; and identify a final response for the inquiry based on a result of the ranking.

In accordance with an exemplary embodiment, the processor may be further configured to generate at least one classification report for the inquiry based on the computed at least one metric, wherein the at least one metric may include a supervised metric and an unsupervised metric.

In accordance with an exemplary embodiment, each of the at least one question may relate to a natural language query that incorporates semantic meaning extracted from the inquiry, the semantic meaning may include subject matter that corresponds to the inquiry.

In accordance with an exemplary embodiment, to generate the at least one question based on the inquiry, the processor may be further configured to apply, via the rephrasing model, a predetermined transformation algorithm to the inquiry to generate each of the at least one question, wherein the predetermined transformation algorithm may perturb the inquiry to retain at least one semantic quality of the inquiry.

In accordance with an exemplary embodiment, the processor may be further configured to independently determine the initial response for each of the at least one question and the inquiry via one of the at least one response model, the initial response may include at least one crowdsourced answer from a dataset.

In accordance with an exemplary embodiment, the at least one metric may include at least one from among an accuracy metric that relates to a baseline accuracy, a robustness metric that relates to correctness of at least one rater, a plurality voting metric that relates to aggregated responses by a mode of a corresponding answer set, an agreement metric that relates to the initial response, and a reliability metric that relates to a measure of internal consistency.

In accordance with an exemplary embodiment, the processor may be further configured to associate feedback data with the corresponding initial response when an agreement metric is below a predetermined agreement threshold, the feedback data may include the at least one metric; and determine, via the at least one response model, a subsequent response for each of the at least one question and the inquiry based on the feedback data.

In accordance with an exemplary embodiment, each of the at least one response model and the rephrasing model may include at least one from among a large language model, a deep learning model, a neural network model, a natural language processing model, a machine learning model, a mathematical model, and a process model.

According to an aspect of the present disclosure, a non-transitory computer readable storage medium storing instructions for facilitating automated model evaluation based on question perturbations is disclosed. The storage medium including executable code which, when executed by a processor, may cause the processor to receive, via an application programming interface, at least one input, each of the at least one input may include an inquiry in a natural language format; generate, via a rephrasing model, at least one question based on the inquiry, each of the at least one question may correspond to a lexical variant of the inquiry; determine, via at least one response model, an initial response for each of the at least one question and the inquiry; cluster the initial response for each of the at least one question and the inquiry into at least one block based on at least one shared characteristic; and compute at least one metric for each of the at least one block.

In accordance with an exemplary embodiment, when executed by the processor, the executable code may further cause the processor to rank the at least one block based on the computed at least one metric; and identify a final response for the inquiry based on a result of the ranking.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for evaluating generated responses of large language models via automated crowdsourcing of question perturbations and corresponding answers.

FIG. 4 is a flowchart of an exemplary process for implementing a method for evaluating generated responses of large language models via automated crowdsourcing of question perturbations and corresponding answers.

FIG. 5 is a flow diagram of an exemplary process for implementing a method for evaluating generated responses of large language models via automated crowdsourcing of question perturbations and corresponding answers.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

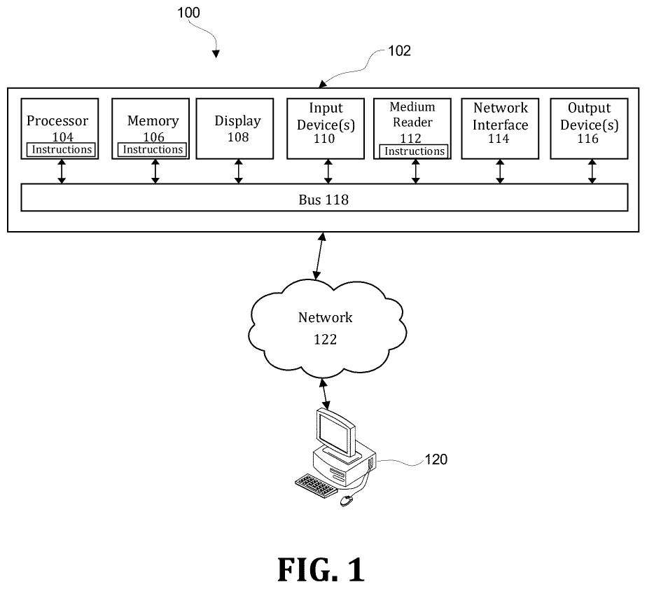

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning system (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for evaluating generated responses of large language models via automated crowdsourcing of question perturbations and corresponding answers.

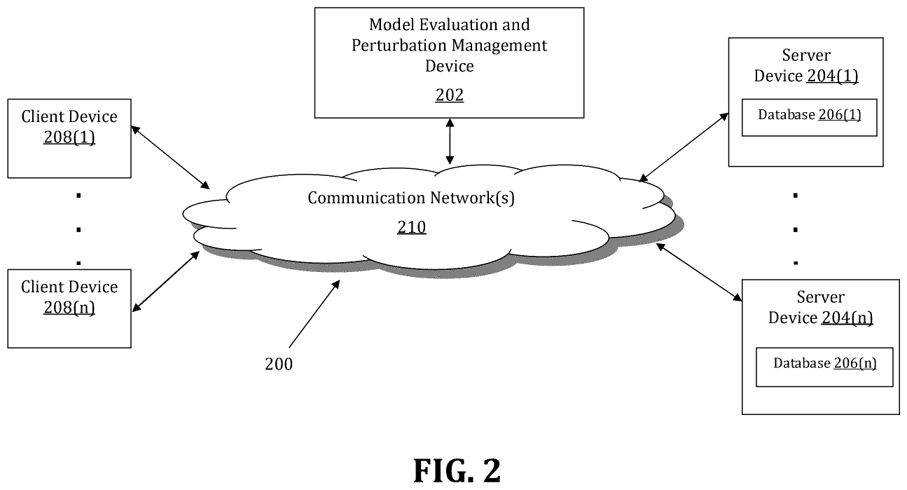

Referring to FIG. 2, a schematic of an exemplary network environment 200 for implementing a method for evaluating generated responses of large language models via automated crowdsourcing of question perturbations and corresponding answers is illustrated. In an exemplary embodiment, the method is executable on any networked computer platform, such as, for example, a personal computer (PC).

The method for evaluating generated responses of large language models via automated crowdsourcing of question perturbations and corresponding answers may be implemented by a Model Evaluation and Perturbation Management (MEPM) device 202. The MEPM device 202 may be the same or similar to the computer system 102 as described with respect to FIG. 1. The MEPM device 202 may store one or more applications that can include executable instructions that, when executed by the MEPM device 202, cause the MEPM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the MEPM device 202 itself, may be located in virtual server(s) running in a cloud-based computing environment rather than being tied to one or more specific physical network computing devices. Also, the application(s) may be running in one or more virtual machines (VMs) executing on the MEPM device 202. Additionally, in one or more embodiments of this technology, virtual machine(s) running on the MEPM device 202 may be managed or supervised by a hypervisor.

In the network environment 200 of FIG. 2, the MEPM device 202 is coupled to a plurality of server devices 204(1)-204(n) that hosts a plurality of databases 206(1)-206(n), and also to a plurality of client devices 208(1)-208(n) via communication network(s) 210. A communication interface of the MEPM device 202, such as the network interface 114 of the computer system 102 of FIG. 1, operatively couples and communicates between the MEPM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the MEPM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and MEPM devices that efficiently implement a method for evaluating generated responses of large language models via automated crowdsourcing of question perturbations and corresponding answers.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The MEPM device 202 may be a standalone device or integrated with one or more other devices or apparatuses, such as one or more of the server devices 204(1)-204(n), for example. In one particular example, the MEPM device 202 may include or be hosted by one of the server devices 204(1)-204(n), and other arrangements are also possible. Moreover, one or more of the devices of the MEPM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the MEPM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to inquiries, natural language data, perturbation questions, lexical variants, initial responses, final responses, clustered blocks, and computed metrics.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the MEPM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the MEPM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the MEPM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the MEPM device 202, the server devices 204(1)-204(n), or the client devices 208(1)-208(n), for example, may be configured to operate as virtual instances on the same physical machine. In other words, one or more of the MEPM device 202, the server devices 204(1)-204(n), or the client devices 208(1)-208(n) may operate on the same physical device rather than as separate devices communicating through communication network(s) 210. Additionally, there may be more or fewer MEPM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

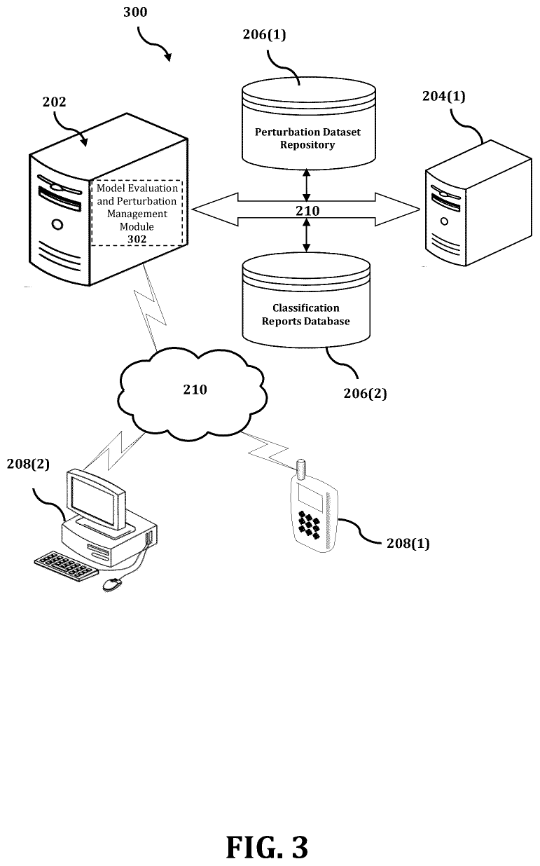

The MEPM device 202 is described and shown in FIG. 3 as including a model evaluation and perturbation management module 302, although it may include other rules, policies, modules, databases, or applications, for example. As will be described below, the model evaluation and perturbation management module 302 is configured to implement a method for evaluating generated responses of large language models via automated crowdsourcing of question perturbations and corresponding answers.

An exemplary process 300 for implementing a mechanism for evaluating generated responses of large language models via automated crowdsourcing of question perturbations and corresponding answers by utilizing the network environment of FIG. 2 is shown as being executed in FIG. 3. Specifically, a first client device 208(1) and a second client device 208(2) are illustrated as being in communication with MEPM device 202. In this regard, the first client device 208(1) and the second client device 208(2) may be “clients” of the MEPM device 202 and are described herein as such. Nevertheless, it is to be known and understood that the first client device 208(1) and/or the second client device 208(2) need not necessarily be “clients” of the MEPM device 202, or any entity described in association therewith herein. Any additional or alternative relationship may exist between either or both of the first client device 208(1) and the second client device 208(2) and the MEPM device 202, or no relationship may exist.

Further, MEPM device 202 is illustrated as being able to access a perturbation dataset repository 206(1) and a classification reports database 206(2). The model evaluation and perturbation management module 302 may be configured to access these databases for implementing a method for evaluating generated responses of large language models via automated crowdsourcing of question perturbations and corresponding answers.

The first client device 208(1) may be, for example, a smart phone. Of course, the first client device 208(1) may be any additional device described herein. The second client device 208(2) may be, for example, a PC. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the MEPM device 202 via broadband or cellular communication. Of course, these embodiments are merely exemplary and are not limiting or exhaustive.

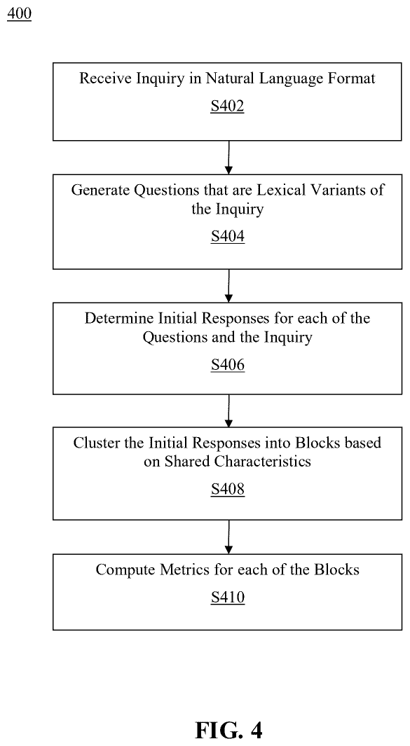

Upon being started, the model evaluation and perturbation management module 302 executes a process for evaluating generated responses of large language models via automated crowdsourcing of question perturbations and corresponding answers. An exemplary process for evaluating generated responses of large language models via automated crowdsourcing of question perturbations and corresponding answers is generally indicated at flowchart 400 in FIG. 4.

In the process 400 of FIG. 4, at step S402, inputs may be received from a user via an application programming interface. In an exemplary embodiment, the inputs may be provided by the user via a graphical user interface. The graphical user interface may enable interactions between the user and computing systems such as, for example, the disclosed system. In another exemplary embodiment, each of the inputs may include an inquiry in a natural language format. The inquiry may relate to a linguistic component such as, for example, a sentence that is worded and/or expressed to elicit information.

At step S404, questions may be generated based on the inquiry. The questions may be generated via a rephrasing model. In an exemplary embodiment, each of the questions may correspond to a lexical variant of the inquiry. The questions may relate to a linguistic component such as, for example, a sentence that is worded and/or expressed to elicit information. In another exemplary embodiment, each of the questions may relate to a natural language query that incorporates semantic meaning extracted from the inquiry. The semantic meaning may include subject matter that corresponds to the inquiry. For example, the questions may correspond to unique variations of the inquiry that retain the original semantic meaning, yet significantly diverges lexically.

In another exemplary embodiment, the questions may be generated by applying predetermined transformation algorithms to the inquiry via the rephrasing model. The predetermined transformation algorithms may be usable to perturb the inquiry while retaining semantic qualities of the inquiry. For example, v+1 transformations may be applied from T for each original query q₀, to perturb the inquiry while retaining the semantic qualities required by the inquiry. Note that the transformation is v+1 because, for a given inquiry q₀, T₀(q₀)=I(q₀)=q₀ may be defined. Therefore, the original question will always be included in the set of transformed questions for subsequent steps. The rephrasing model may be usable to rewrite the inquiry in n radically different ways.

Furthermore, for the aforementioned example, one prompt call may be sufficient to discourage duplicates. Temperature for all analysis may be set to 1.0 to prioritize creativity. In effect, the exemplary generation process may be summarized as returning a set of [symbol] question perturbations of size v+1, such that:

$$= 𝒯 ( {q}_{0} ) = [ \begin{matrix}I ( {q}_{0} ) \\ {T}_{1} ( {q}_{0} ) \\ ⋮ \\ {T}_{v} ( {q}_{0} )\end{matrix} ] = [ \begin{matrix}{q}_{0} \\ {q}_{1} \\ ⋮ \\ {q}_{v}\end{matrix} ] .$$

In another exemplary embodiment, the rephrasing model may include at least one from among a large language model, a deep learning model, a neural network model, a natural language processing model, a machine learning model, a mathematical model, and a process model. The rephrasing model may also include stochastic models such as, for example, Markov models that are usable to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, support vector machine (SVM) analysis, logistic regression analysis, etc. In another exemplary embodiment, machine learning analytical techniques may include unsupervised learning algorithms such as, for example, Apriori algorithm analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the machine learning process may include a neural network that relates to at least one from among an artificial neural network and a simulated neural network. The neural network may correspond to a technique in artificial intelligence that teaches computers to process data by using interconnected processing nodes and/or artificial neurons. The neural network may relate to a type of machine learning such as, for example, deep learning that uses interconnected nodes and/or artificial neurons in a layered structure to transform inputs for predictive analytics.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, the large language model may relate to a trained deep-learning model that understands and generates text in a human-like fashion. The large language model may recognize, summarize, translate, predict, and generate various types of text as well as content based on knowledge gained from massive data sets. In another exemplary embodiment, the large language model may correspond to a language model that consists of a neural network with many parameters such as, for example, weights. The language model may be trained on large quantities of unlabeled and labeled text by using self-supervised learning or semi-supervised learning. The trained language model may be usable to capture syntax and semantics of human language.

In another exemplary embodiment, the natural language processing model may correspond to a plurality of natural language processing techniques. The natural language processing techniques may include at least one from among a sentiment analysis technique, a named entity recognition technique, a summarization technique, a topic modeling technique, a text classification technique, a keyword extraction technique, and a lemmatization and stemming technique. As will be appreciated by a person of ordinary skill in the art, natural language processing may relate to computer processing and analyzing of large quantities of natural language data.

At step S406, initial responses may be determined for each of the questions and the inquiry. The initial responses may be determined via response models. In an exemplary embodiment, the initial responses for each of the questions and the inquiry may be independently determined by one of the response models. The initial responses may include crowdsourced answers from a dataset. Response models such as, for example, independent, large language model answering agents may be established to crowdsource answers from perturbations.

For example, given the perturbed question set [symbol] for a sample xⱼ, response models may be employed according to |Tⱼ|=v+1 to generate answers aⱼ∈A for each variation qᵢ∈ [symbol] . For each question elicited by the rephrasing model, a new generation process may be launched to answer the new question. Depending on the analysis, the response models may receive a prompt with the question qᵢ, alongside context cᵢ or candidate choices kᵢ∈K, when applicable.

In another exemplary embodiment, consistent with present disclosures, the response models may include at least one from among a large language model, a deep learning model, a neural network model, a natural language processing model, a machine learning model, a mathematical model, and a process model.

At step S408, the initial responses for each of the questions and the inquiry may be clustered into blocks. The initial responses may be clustered into blocks based on shared characteristics. In an exemplary embodiment, the shared characteristics may relate to the subject matter of the initial responses. For example, all initial responses with subject matter A may be grouped together into one block. In another exemplary embodiment, the shared characteristics may be predetermined by the user based on preference. For example, the shared characteristics may relate to a specific answer choice from an initial set of multiple answer choices.

At step S410, metrics may be computed for each of the blocks. In an exemplary embodiment, metric may relate to measures of quantitative assessment that are commonly used for assessing, comparing, and tracking performance. Consistent with present disclosures, the metrics may be usable to measure model confidence, model consistency, and quantification of model hallucinations.

In another exemplary embodiment, the metrics may include at least one from among an accuracy metric that relates to a baseline accuracy, a robustness metric that relates to correctness of at least one rater, a plurality voting metric that relates to aggregated responses by a mode of a corresponding answer set, an agreement metric that relates to the initial response, and a reliability metric that relates to a measure of internal consistency. Since the original inquiry q₀ is in answer set A, the baseline accuracy may be juxtaposed against ensemble metrics such as, for example, a robustness metric (worst-case performance) best-case performance, and plurality-based accuracy.

Consistent with present disclosures, robustness may be measured in the worst-case (one or more raters is incorrect) and best-case (one rater is correct) scenarios. For example, when m is the indicator function for accuracy, A may be the baseline accuracy for n samples. In addition, when Ω represents the robustness, i.e., worst-case performance under perturbations Tⱼ(xⱼ), then O may be the best-case performance. Finally, given the set of v+1 raters, Y may be the aggregate responses by the mode of answer set A, as a proxy for plurality voting. The resulting calculation may be represented as:

$$m ( f ( x ) , y ) = {𝕀}_{f ( x ) = y}$$

$$A = \frac{1}{n} {\sum }_{j = 1}^{n} m ( f ( {x}_{j} ) , {y}_{j} )$$

$$Ω = \frac{1}{n} {\sum }_{j = 1}^{n} {min}_{i} m ( f ( {T}_{i} ( {x}_{j} ) ) , {y}_{j} ) \leq A$$

$$O = \frac{1}{n} {\sum }_{j = 1}^{n} {max}_{i} m ( f ( {T}_{i} ( {x}_{j} ) ) , {y}_{j} ) \geq A$$

$$\hat{Y} = \frac{1}{n} {\sum }_{j = 1}^{n} m ( mode \{ f ( {T}_{i} ( {x}_{j} ) ) \vert {T}_{i} ∈ 𝒯 \} , {y}_{j} )$$

Since T₀(x) is the identity function I, the relationship between accuracy, robustness, and best-case performance may be represented as: Ω≤A≤O. When the raters randomly guess, then A and Y for k choices would be 1/k. The worst-case would approach,

$${lim}_{k \to ∞} {( \frac{1}{k} )}^{v + 1} \approx 0 .$$

The best-case is,

$$1 - {( \frac{k - 1}{k} )}^{( v + 1 )} ,$$

which is the probability of one success for v+1 trials.

In another exemplary embodiment, the agreement metric may include an item difficulty metric, a mean normalized certainty metric, a Gibbs' M2 Index, and a Fleiss's metric. For the item difficulty metric, the average item difficulty μ_{D} may be the mean percentage of correct responses per question. The item difficulty metric may relate to a measure of the collective difficulty of the questions for the large language model raters. The baseline for random guessing may be expected value of a Bernoulli distribution. The item difficulty metric may be represented as:

$${μ}_{D} = \frac{1}{n} {\sum }_{j = 1}^{n} \frac{1}{\vert 𝒯 \vert} {\sum }_{{T}_{i} ∈ 𝒯} m ( f ( {T}_{i} ( {x}_{j} ) ) , {y}_{j} ) .$$

For the mean normalized certainty metric, entropy H may quantify the degree of uncertainty in a set of qualitative responses. The entropy may be maximized for uniform distributions (complete uncertainty) while minimized for consistent categorizations. The rater entropy H may be normalized by the maximum entropy allowed Hₘₐₓ. The scale may be reversed such that 1 indicates certainty and 0 may represent uncertainty. Let fᵢ denote the frequency of answer kᵢ for sample xⱼ, and Kⱼ=|Kⱼ| be the number of choices. Then proportion pᵢ and mean normalized certainty (MNC) Hη is:

$${p}_{i} = \frac{{f}_{i}}{v + 1}$$

$$\begin{matrix}{H}_{η} = 1 - 𝔼 [ \frac{H}{{H}_{max}} ] \\ = 1 + \frac{1}{n} {\sum }_{j = 1}^{n} [ {\sum }_{i = 0}^{{K}_{j}} \frac{{p}_{i} {log}_{b} ( {p}_{i} )}{{log}_{b} ( {K}_{j} )} ] .\end{matrix}$$

The Gibbs' M2 index may relate to a standardized metric measuring the ratio of the variance of a multinomial distribution to the variance of a binomial; since each perturbation is an independent trial, and the answer responses may be categorized into exactly one of k outcomes, each round of question and answer is a multinomial simulation. Therefore, let pᵢ be the proportion of observations for the i-th category and Kⱼ=|Kⱼ| be the number of categories. For readability, the index may be reversed such that M₂=1 when the raters are certain and 0 when uniform. As such,

$${M}_{2} = 1 - \frac{1}{n} {\sum }_{j = 1}^{n} [ \frac{{K}_{j}}{{K}_{j} - 1} ( 1 - {\sum }_{i = 0}^{{K}_{j}} {p}_{i}^{2} ) ] .$$

For Fleiss's metric, inter-rater agreement may be measured through Fleiss' generalized κ. This metric calculates the degree of agreement in responses over what would be expected by random chance, 1 indicating complete agreement (and 0 for none). Let fᵢ be the frequency of answer choice kᵢ for sample xⱼ, then the expected agreement by chance Pₑ and observed agreement Pₒ for v+1 raters is,

$${\overline{P}}_{e} = {\sum }_{i = 0}^{{K}_{j}} {( \frac{1}{n ( v + 1 )} {\sum }_{j = 1}^{n} {f}_{i} )}^{2}$$

$${P}_{j} = \frac{1}{v ( v + 1 )} [ ( {\sum }_{i = 0}^{{K}_{j}} {f}_{i}^{2} ) - ( v + 1 ) ]$$

$${\overline{P}}_{o} = \frac{1}{n} {\sum }_{j = 1}^{n} {P}_{j} .$$

Then κ may be the ratio of the degree of agreement achieved over the degree of agreement attainable through pure chance. Note that κ may be affected by the number of raters and categories, with fewer categories often yielding higher a values.

In another exemplary embodiment, the reliability metric may be usable for measures of internal consistency. Cronbach's α may be relied upon for dichotomous choices, in which 1 is for correct and 0 is for incorrect. Cronbach's α is widely accepted in testing theory and is equivalent to the Kuder-Richardson Formula 20 (KR-20) for binary data. Letting n be the number of samples, σ_{y}² be each sample's score variance across the v+1 raters, and σₓ² be the variance across the total count of correct responses per rater. Then Cronbach's α may be defined as:

$$α = \frac{n}{n - 1} ( 1 - \frac{{\sum }_{j = 1}^{n} {σ}_{y}^{2}}{{σ}_{x}^{2}} ) .$$

In another exemplary embodiment, the blocks may be ranked based on the computed metrics. Then, final responses to the inquiry may be identified based on a result of the ranking. For example, to make the answers more digestible for understanding, a semantic paraphrase model may be used to cluster answers into the blocks. Next, an answer-critic model may be applied to re-rank each block's responses to the answer aᵢ∈A that best aligns with the original question q₀.

In another exemplary embodiment, classification reports may be generated for the inquiry based on the computed metrics. The classification reports may include visual representations such as, for example, graphs and charts that illustrate the computed metrics. The computed metrics may include supervised metrics and unsupervised metrics. For example, a visual classification report based on supervised and unsupervised metrics may be produced. Note that meaningful supervised metrics may only be applicable during live inference when the user selects a block of answers as the ground truth. Otherwise, all metrics may be computed for each block as the ground truth (i.e., show accuracy whether cluster 1 is correct, then whether cluster 2 is correct, etc.).

In another exemplary embodiment, feedback data may be associated with the corresponding initial response. The feedback data may be associated when an agreement metric is below a predetermined agreement threshold. The feedback data may include the computed metrics. For example, when agreement is low between the independent, large language model agents, feedback data such as information relating to answer dispersion amongst the agents may be aggregated for additional context. Then, subsequent responses for each of the questions and the inquiry may be determined based on the feedback data. The subsequent responses may be determined taking into account the additional context. Consistent with present disclosures, the subsequent responses may be determined via the response models.

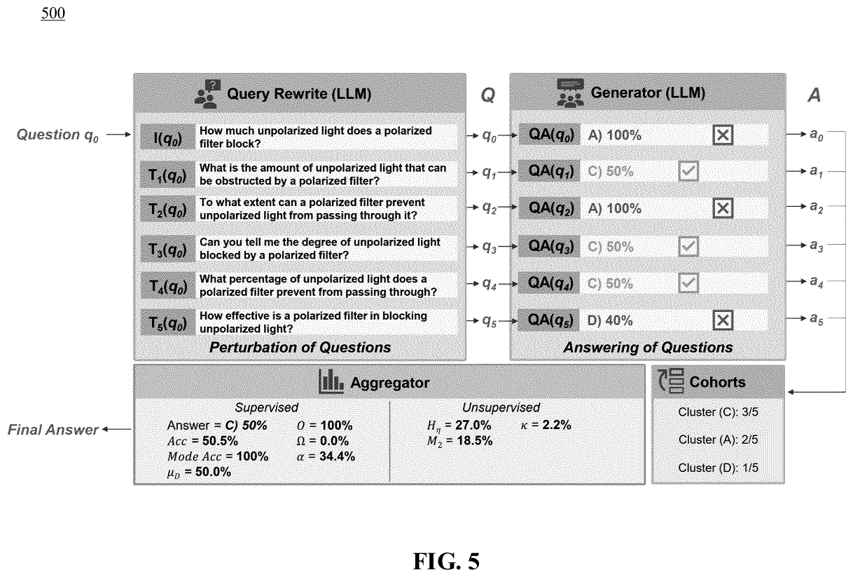

FIG. 5 is a flow diagram of an exemplary process for implementing a method for evaluating generated responses of large language models via automated crowdsourcing of question perturbations and corresponding answers. In FIG. 5, a systematic approach is disclosed for evaluating the robustness and consistency of generated responses by automatically crowdsourcing question perturbations through independent, large language model agents. The approach may provide clarity in the generation space of responses and may offer an effective way to visually inspect disagreements as well as variability. Additionally, the approach may offer an infrastructure to measure confidence, consistency, and quantification of model hallucinations.

Consistent with present disclosures, the approach in FIG. 5 may leverage three main components. The first component may include a rephrasing model such as, for example, a large language model rewriter agent that perturbs the original question q₀ into a collection of v=5 variations {q₁, . . . , qᵥ}, although the present disclosure includes any combination of variations. The second component may include a plurality of response models such as, for example, independent, large language model agents that answer each perturbed question without sharing context. The number of response models may be determined by using v+1=6 to ensure that the original question is adequately answered.

Finally, the third component may relate to an aggregator that can cluster answers based on semantic similarity, re-rank answers within a block, and provide supervised as well as unsupervised metrics. The third component may be usable to provide holistic evidence per question to quantify robustness. In another exemplary embodiment, the first component and the second component may enable the automatic crowdsourcing that creates a perturbation dataset. The perturbation dataset may relate to a corpus of perturbed questions, unique variations that retain the original semantic meaning of the questions, and answers.

As illustrated in FIG. 5, A single question q₀ that is supplied by the user may be perturbed in v different ways (while retaining the original question via the identify function). Next, each question qᵢ∈T may be independently answered by the independent, large language model agents. Finally, various metrics may be computed for the block of answers based on the perturbations. In a practical setting, these variations may be fed into the aggregator to organize and re-rank answers according to the user's preferences and the original question. Aggregated statistics may be compiled from random permutations of the result set across raters, with labels remapped, to simulate large-scale item analysis.

Accordingly, with this technology, an optimized process for evaluating generated responses of large language models via automated crowdsourcing of question perturbations and corresponding answers is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating automated model evaluation based on question perturbations, the method being implemented by at least one processor, the method comprising:
receiving, by the at least one processor via an application programming interface, at least one input, each of the at least one input including an inquiry in a natural language format;
generating, by the at least one processor via a rephrasing model, at least one question based on the inquiry, each of the at least one question corresponding to a lexical variant of the inquiry;
determining, by the at least one processor via at least one response model, an initial response for each of the at least one question and the inquiry;
clustering, by the at least one processor, the initial response for each of the at least one question and the inquiry into at least one block based on at least one shared characteristic; and
computing, by the at least one processor, at least one metric for each of the at least one block.

2. The method of claim 1, further comprising:
ranking, by the at least one processor, the at least one block based on the computed at least one metric; and
identifying, by the at least one processor, a final response for the inquiry based on a result of the ranking.

3. The method of claim 1, further comprising:
generating, by the at least one processor, at least one classification report for the inquiry based on the computed at least one metric,
wherein the at least one metric includes a supervised metric and an unsupervised metric.

4. The method of claim 1, wherein each of the at least one question relates to a natural language query that incorporates semantic meaning extracted from the inquiry, the semantic meaning including subject matter that corresponds to the inquiry.

5. The method of claim 1, wherein the generating of the at least one question based on the inquiry further comprises:
applying, by the at least one processor via the rephrasing model, a predetermined transformation algorithm to the inquiry to generate each of the at least one question,
wherein the predetermined transformation algorithm perturbs the inquiry to retain at least one semantic quality of the inquiry.

6. The method of claim 1, wherein the initial response for each of the at least one question and the inquiry is independently determined by one of the at least one response model, the initial response including at least one crowdsourced answer from a dataset.

7. The method of claim 1, wherein the at least one metric includes at least one from among an accuracy metric that relates to a baseline accuracy, a robustness metric that relates to correctness of at least one rater, a plurality voting metric that relates to aggregated responses by a mode of a corresponding answer set, an agreement metric that relates to the initial response, and a reliability metric that relates to a measure of internal consistency.

8. The method of claim 1, further comprising:
associating, by the at least one processor, feedback data with the corresponding initial response when an agreement metric is below a predetermined agreement threshold, the feedback data including the at least one metric; and
determining, by the at least one processor via the at least one response model, a subsequent response for each of the at least one question and the inquiry based on the feedback data.

9. The method of claim 1, wherein each of the at least one response model and the rephrasing model includes at least one from among a large language model, a deep learning model, a neural network model, a natural language processing model, a machine learning model, a mathematical model, and a process model.

10. A computing device configured to implement an execution of a method for facilitating automated model evaluation based on question perturbations, the computing device comprising:
a processor;
a memory; and
a communication interface coupled to each of the processor and the memory,
wherein the processor is configured to:
receive, via an application programming interface, at least one input, each of the at least one input including an inquiry in a natural language format;
generate, via a rephrasing model, at least one question based on the inquiry, each of the at least one question corresponding to a lexical variant of the inquiry;
determine, via at least one response model, an initial response for each of the at least one question and the inquiry;
cluster the initial response for each of the at least one question and the inquiry into at least one block based on at least one shared characteristic; and
compute at least one metric for each of the at least one block.

11. The computing device of claim 10, wherein the processor is further configured to:
rank the at least one block based on the computed at least one metric; and
identify a final response for the inquiry based on a result of the ranking.

12. The computing device of claim 10, wherein the processor is further configured to:
generate at least one classification report for the inquiry based on the computed at least one metric,
wherein the at least one metric includes a supervised metric and an unsupervised metric.

13. The computing device of claim 10, wherein each of the at least one question relates to a natural language query that incorporates semantic meaning extracted from the inquiry, the semantic meaning including subject matter that corresponds to the inquiry.

14. The computing device of claim 10, wherein, to generate the at least one question based on the inquiry, the processor is further configured to:
apply, via the rephrasing model, a predetermined transformation algorithm to the inquiry to generate each of the at least one question,
wherein the predetermined transformation algorithm perturbs the inquiry to retain at least one semantic quality of the inquiry.

15. The computing device of claim 10, wherein the processor is further configured to independently determine the initial response for each of the at least one question and the inquiry via one of the at least one response model, the initial response including at least one crowdsourced answer from a dataset.

16. The computing device of claim 10, wherein the at least one metric includes at least one from among an accuracy metric that relates to a baseline accuracy, a robustness metric that relates to correctness of at least one rater, a plurality voting metric that relates to aggregated responses by a mode of a corresponding answer set, an agreement metric that relates to the initial response, and a reliability metric that relates to a measure of internal consistency.

17. The computing device of claim 10, wherein the processor is further configured to:
associate feedback data with the corresponding initial response when an agreement metric is below a predetermined agreement threshold, the feedback data including the at least one metric; and
determine, via the at least one response model, a subsequent response for each of the at least one question and the inquiry based on the feedback data.

18. The computing device of claim 10, wherein each of the at least one response model and the rephrasing model includes at least one from among a large language model, a deep learning model, a neural network model, a natural language processing model, a machine learning model, a mathematical model, and a process model.

19. A non-transitory computer readable storage medium storing instructions for facilitating automated model evaluation based on question perturbations, the storage medium comprising executable code which, when executed by a processor, causes the processor to:
receive, via an application programming interface, at least one input, each of the at least one input including an inquiry in a natural language format;
generate, via a rephrasing model, at least one question based on the inquiry, each of the at least one question corresponding to a lexical variant of the inquiry;
determine, via at least one response model, an initial response for each of the at least one question and the inquiry;
cluster the initial response for each of the at least one question and the inquiry into at least one block based on at least one shared characteristic; and
compute at least one metric for each of the at least one block.

20. The storage medium of claim 19, wherein, when executed by the processor, the executable code further causes the processor to:
rank the at least one block based on the computed at least one metric; and
identify a final response for the inquiry based on a result of the ranking.
